(19) United States
(12) Patent Application Publication
(10) Pub. No.: US 2017/0210422 A1
(43) Pub. Date: Jul. 27, 2017

(54) DEVICE FOR ADJUSTING CAMBER AND/OR TOE OF THE WHEELS OF MOTOR VEHICLES

(71) Applicant: AUDI AG, 85045 Ingolstadt (DE)

(72) Inventors: WOLFGANG SCHMID, Freising (DE); THOMAS KLINGER, Ingolstadt (DE); ACHIM GLAS, Gaimersheim (DE)

(73) Assignee: AUDI AG, 85045 Ingolstadt (DE)

(21) Appl. No.: 15/329,053

(22) PCT Filed: Jul. 8, 2015
(86) PCT No.: PCT/EP2015/001392

§ 371 Date: Jan. 25, 2017

(30) Foreign Application Priority Data
Jul. 26, 2014 (DE) 10 2014 011 191.1

(51) Int. Cl. B62D 17/00; B60G 17/015; B60G 7/00

(52) U.S. Cl. CPC B62D 17/00; B60G 7/006; B60G 17/0157; B60G 2200/46; B60G 2200/462; B60G 2202/42; B60G 2204/418

(57) ABSTRACT

A device for adjusting camber and/or toe of a vehicle wheel of a motor vehicle includes a wheel carrier at which the vehicle wheel is rotatably mounted in a wheel bearing and which includes a wheel-side carrier part, an axle-side guide part and wheel-side and axle-side rotary parts arranged there between. The rotary parts are supported at a common bearing point for rotation relative to one another about a rotation axis about which the wheel-side rotary part is pivotable for toe or camber adjustment of the vehicle wheel about a wobble point. The wheel-side carrier part supports a brake caliper which interacts with a brake disc of the vehicle wheel. The wheel-side carrier part is supported upon the wheel-side rotary part via a pivot bearing.

The invention relates to a device for adjusting camber and/or toe of a motor vehicle wheel according to the preamble of claim 1.

When cornering, the lateral forces acting on the vehicle wheel generate a very high tilting moment that acts on the wheel carrier. It is therefore necessary, to construct especially the wheel bearing that is integrated in the wheel carrier very stiff in camber direction.

WO 2010 034 370 A1 discloses a generic prior art in which a bearing assembly, comprised of the wheel-side and axle-side rotary parts, is axially clamped between a wheel-side carrier part (i.e. brake caliper support) and an axle-side guide part. The axle-side guide part supports an electric motor for rotating the axle-side rotary part. In addition, control arms of a wheel suspension can be articulated to the axle-side guide part. The wheel-side carrier part is provided for rotatable support of the vehicle wheel and supports a brake caliper which interacts with the brake disc of the vehicle wheel.

In WO 2010 034 370 A1, the rotary parts are rotatably mounted relative to one another and in relation to the carrier part and the guide part. Moreover, a wheel bearing for the vehicle wheel is integrated in the wheel-side guide part, so that overall four bearing points are established, which are arranged in series in a wheel force flux. Such a series arrangement of four bearing points is accompanied by a reduction of the camber stiffness of the arrangement. As a result, the bearing points have to be configured very stiff in the camber direction through appropriate measures (increase of bearing diameter, etc., for example). This causes increased space demands as well as an increase in weight of the structure.

WO 1998/016418 A1 represents another prior art in which a standardized brake system, as installed in common axle concepts, cannot be used. In the WO-publication, a vehicle wheel is rotatably mounted in a wheel bearing of a wheel carrier. The wheel carrier is made of two parts with wheel-side and axle-side rotary parts that are adjustable relative to one another. The rotary parts interact with confronting slanted cylindrical surfaces which define the rotation axis that is inclined in relation to the rotation axis of the axle-side rotary part. The toe/camber adjustment is implemented by turning the rotary parts in a same direction or in opposite directions, so that the vehicle wheel pivots by corresponding angle degrees in the toe and camber angle. The wheel-side rotary part of the wheel carrier forms in addition a radially outer bearing housing of the wheel bearing for rotatably accommodating a wheel hub portion of a wheel flange that supports the vehicle wheel. As mentioned above, such an axle concept is unsuitable for use with a standardized brake system, comprised of a brake caliper which is mounted to the wheel carrier and is engageable with a brake disc mounted to the vehicle wheel. The reason being that the brake disc in such a brake system is to be secured on the conjointly pivoting wheel hub, and the brake caliper has to be secured to the wheel carrier in order to be able to transmit the braking torques. For this purpose, above WO publication fails to provide any support structure to which the brake caliper can be mounted.

The object of the invention is to provide a device that is both easy to produce and can be configured sufficiently stiff with respect to encountered wheel forces.

The object is achieved by the features of claim 1. Preferred refinements of the invention are disclosed in the dependent claims.

The invention is based on the problem that in the prior art according to WO 2010 034 370 A1 during braking or cornering a total of four bearing points of the wheel carrier are established in the wheel force flux from the vehicle wheel to the vehicle body, so that these four bearing points are to be constructed correspondingly robust. Against this background, the wheel-side carrier part (that is, the brake caliper support) is supported via a pivot bearing on the wheel-side rotary part.

In accordance with the invention, the wheel bearing is, therefore, no longer (like in WO 2010 034 370 A1) directly mounted to the wheel-side carrier part. The wheel-side carrier part thus no longer supports directly the wheel bearing, but merely the brake caliper and, possibly, the drive motor for the wheel-side rotary part. As a result, the bearing point between the wheel-side rotary part and the wheel-side guide part (i.e. the brake caliper support) is removed from the wheel force flux and thus relieved from any force. This results in only three bearing points that are positioned in series in the wheel force flux. The fourth bearing point, i.e. the pivot bearing between the wheel-side carrier part and the wheel-side rotary part, can be dimensioned in contrast thereto smaller since any forces and torques acting upon this pivot bearing from the brake system for example are much smaller. Furthermore, the removal of the fourth bearing point from the wheel force flux increases the camber stiffness of the bearing assembly, so that the remaining bearing points again can be dimensioned smaller while maintaining the camber stiffness constant. Overall, compared to the art, the demand for installation space and the structural weight of the device are significantly reduced.

Preferably, the wheel-side carrier part can be arranged radially outside the wheel-side rotary part so that the device can be designed particularly compact in axial direction. In this case, the carrier part can be supported via a radially inner bearing surface upon a radial outer bearing surface of the wheel-side rotary part with interposition of the pivot bearing.

The axle-side rotary part and the wheel-side rotary part can each be in driving connection with a drive motor. Preferably, the rotary parts can each be components of a gear drive in which the electric motor drives the axle-side and/or wheel-side rotary part via a gear stage. As the rotary parts rotate in a same direction or in opposite directions, the carrier part pivots about a predefined toe and/or camber angle. A particular space-saving arrangement is established, when the wheel-side rotary part has a gear portion which is a component of the afore-mentioned gear drive and arranged, as viewed in axial direction, between the carrier-part support point and the slanted surface of the wheel-side rotary part.

According to an optional refinement of the invention, the wheel-side rotary part may at the same time assume the dual function of forming the outer bearing housing of the wheel bearing. In correspondence thereto, a wheel hub portion may be rotatably mounted radially inwards of the rotary part forming the outer bearing housing and transitions in transverse direction outwardly into a wheel flange supporting the vehicle wheel. The outer bearing races of the wheel bearing may be incorporated directly on the inner circumference of the wheel-side rotary part. It may, however, be preferred in terms of a simpler customer service, to use a wheel bearing that can be dismantled and has bearing outer races that are not directly incorporated on the inner circumference of the wheel-side rotary part.

To enable simple incorporation of the device in a conventional wheel suspension in a simple manner in terms of manufacture, the wheel carrier can have an axle-side guide part. The control arms, the stabilizer coupling points and/or dampers/springs of the wheel suspension of the vehicle can be articulated to the axle-side guide part. In addition, the guide part can be supported on the axle-side rotary part in a dynamically decoupled manner, i.e. via a pivot bearing. The guide part can be arranged radially outside of the axle-side rotary part, like the wheel-side carrier part. In this case, the guide part can be supported via a radially inner bearing surface upon a radial outer bearing surface of the axle-side rotary part with interposition of the pivot bearing.

A torque transmitting element can, preferably, be positioned between the carrier part and the guide part, while forming a torque path, in which a torque, in particular a braking torque, is transferred from the carrier part to the guide part, and the axle-side and wheel-side rotary parts are bridged.

The configurations and/or refinements of the invention, as described above and/or set forth in the subclaims may be used individually or also in any combination with one another—except, for example, in cases of unambiguous dependencies or incompatible alternatives.

The invention and its advantageous configurations and refinements as well as their advantages will be described in greater detail hereinafter with reference to drawings.

It is shown in:

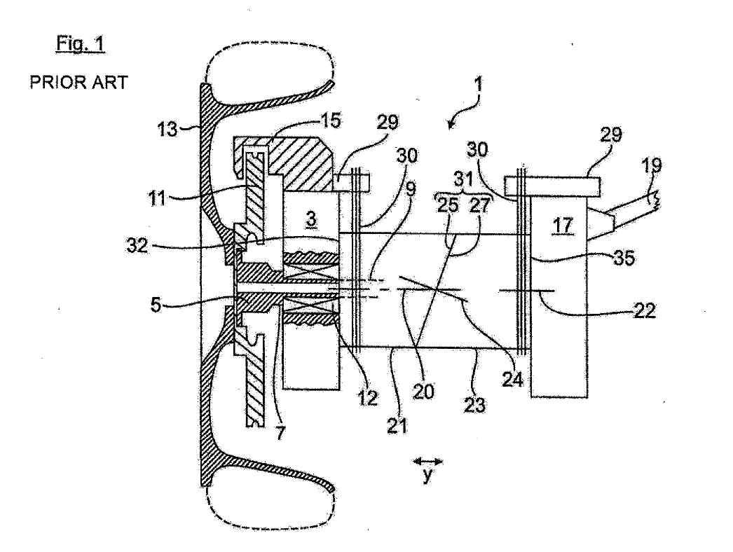

FIG. 1 a principal illustration of a prior art device for adjusting toe and camber angles of a motor vehicle wheel;

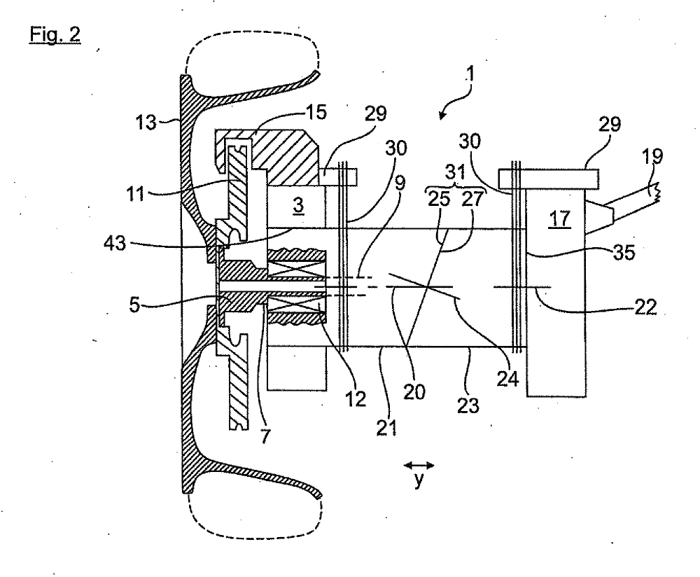

FIG. 2 a representation according to FIG. 1 with the device having the realized invention incorporated therein; and

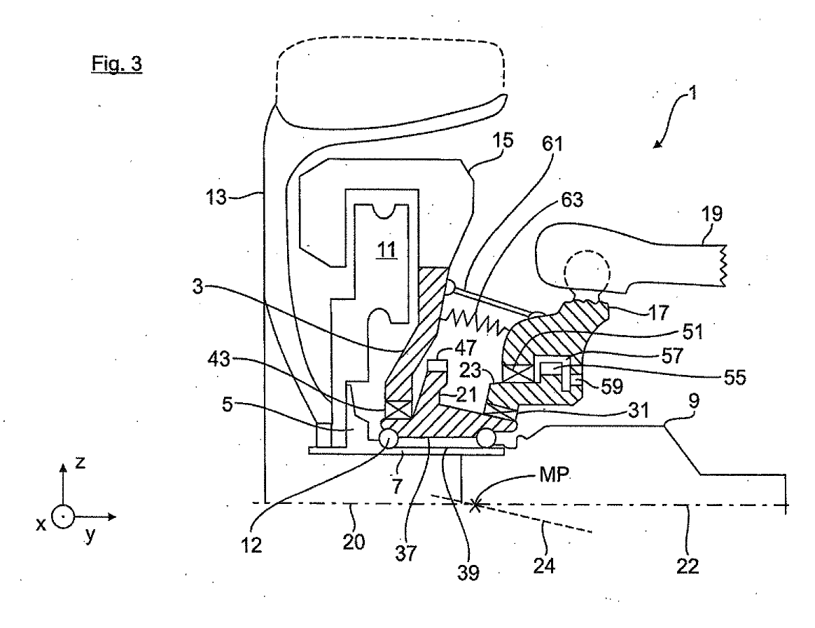

FIG. 3 a half-section of the upper half of device according to the invention by way of a representational configuration.

For ease of understanding, FIG. 1 shows a rough schematic illustration of a wheel carrier 1 of a vehicle wheel 13 as known in the art and not covered by the invention.

The wheel carrier 1 includes a carrier part 3, in which a wheel flange 5 is rotatably mounted with its hub portion 7 in a wheel bearing 12. A brake disc 11 and a vehicle wheel 13 with its rim are mounted to the wheel flange 5. The brake disc 11 together with a brake caliper 15, mounted on the carrier part, are components of a brake system. Guided through the wheel carrier 1 is a cardan shaft which propels the vehicle wheel 13 and has a constant-velocity joint (shown only in FIG. 3 with reference numeral 9) to which a central screw, also not shown, is threadably engaged, to brace the wheel bearing 12 via the wheel hub 5 and the constant-velocity joint 9.

In addition, the wheel carrier 1 includes an axle-side guide part 17 to which a control arm 19 of the wheel suspension is articulated in FIG. 1 by way of example. Two rotary parts 21, 23 as adjusting elements are provided between the carrier part 3 and the guide part 17. The rotary part 21 is rotatably connected at a bearing point 32 with the carrier part 3 while defining a rotary-part axis 20. The rotary part 23 is connected at a bearing point 35 with the guide part 17 while defining a rotation axis 22. FIG. 1 shows the two rotary parts 21, 23 to be in sliding and/or rolling-contact bearing relative to one another via a common bearing point 31, i.e. via flat slanted surfaces 25, 27 and rotatably connected with one another via a rotation axis 24. The rotation axis 24 is oriented in FIG. 1 at an incline perpendicular to the slanted surfaces 25, 27 and at a defined angle in relation to the rotation axis 22 of the axle-side rotary part 23.

FIG. 1 shows, by way of example, the rotary-part axes 20 and 22 in identical position with the wheel axle. In a departure therefrom, the rotary part 21 can be arranged not coaxially with respect to the wheel axle, but the rotary-part axis 20 and the wheel axle may also be slanted in relation to one another.

Provided to each of the carrier part 3 and the guide part 17 is an electric servomotor 29 which is in driving relation with the rotary parts 21, 23 via gear drives 30. The servomotors 29 are able to rotate the two rotary parts 21, 23 in a same direction or in opposite directions in both rotation directions, so that the carrier part 3 executes a pivotal movement or wobble movement about a momentary pole MP (FIGS. 2 to 5) in relation to the guide part 17 to thereby correspondingly modify the toe angle and/or camber angle of the vehicle wheel 13.

In FIG. 1, the bearing point 32 is thus formed between the wheel-side carrier part 3 and the wheel-side rotary part 21, the common bearing point 31, comprised of the two slanted surfaces 25, 27, is thus formed between the two rotary parts 21, 23, and a further bearing point 35 is thus formed between the axle-side rotary part 23 and the guide part 17. The wheel bearing 12 is mounted in FIG. 1 directly in the wheel-side carrier part 3. When braking or cornering a total of the four bearing points 12, 32, 31, 35 are established in the wheel force flux from the vehicle wheel 13 to the vehicle body and have to be constructed correspondingly robust. These four bearing points 12, 32, 31, 35 are arranged in series in the wheel force flux. Such a series arrangement of the four bearing points 12, 32, 31, 35 is accompanied with a reduction of the camber stiffness of the arrangement. Accordingly, the bearing points 12, 32, 31, 35 are to be constructed in the camber direction very stiff through appropriate measures (increase of bearing diameter, etc., for example). This causes increased space demands as well as an increase in weight of the structure.

FIG. 2 shows a wheel carrier 1 according to the invention, in which, as opposed to FIG. 3 to be described later, the connecting rod acting as torque bridge is not visible. In contrast to FIG. 1, the wheel bearing 12 is mounted in FIG. 2 no longer directly to the wheel-side carrier part 3, but rather directly mounted within the wheel-side rotary part 21. The carrier part 3 is supported upon the outer circumference of the wheel-side rotary part 21 via a bearing point 43. In FIG. 2, the wheel-side carrier part 3 thus no longer supports the wheel bearing 12 directly, but merely the brake caliper 15 and the drive motor 29 for the wheel-side rotary part 21. As a result, the bearing point 43 between the wheel-side rotary part 21 and the wheel-side carrier part 3 is removed from the wheel force flux and thus relieved from any forces. This results in that three bearing points 12, 31, and 35 only are arranged in series in the wheel force flux, as will be described again in greater detail with reference to FIG. 3.

FIG. 3 shows an exemplified technical implementation of the device illustrated in FIG. 2. In contrast to FIGS. 1 and 2, the two rotary parts 21, 23 do no longer contact each other via flat slanted surfaces 25, 27 in order to define the inclined rotation axis 24, but via a common pivot bearing point 31. This pivot bearing point may be realized for example as rolling-contact bearing or sliding bearing or also a combination of several of these bearings, which substantially maintain all translation and rotation directions up to the rotation axis. This generalization is true also for the other bearing points, described in the figures.

FIG. 3 shows in addition that the wheel bearing 12 is no longer directly integrated in the wheel-side carrier part 3, but rather directly within the wheel-side rotary part 21. In FIG. 3, the outer bearing races and the inner bearing races of the wheel bearing 12 are incorporated, purely by way of example, directly in the inner circumference 37 of the wheel-side rotary part 21 and directly in the outer circumference 39 of the hub portion 7 of the wheel flange 5. Correspondingly, the wheel-side rotary part 21 in FIG. 2 assumes a dual function also as an outer bearing housing of the wheel bearing 12. At the outer circumference of the wheel-side rotary part 21, the carrier part 3 is supported on the outside in vehicle transverse direction y radially outside upon the wheel-side rotary part 21 via a bearing point 43. The bearing point 43 has to be configured to be able to absorb tilting moments.

Deviating from FIG. 3, an alternate technical implementation is possible that involves a design of the wheel bearing 12 that can be dismantled, and more specifically with a radially outer bearing housing which can be dismantled, i.e. mounted, for example via a press fit or by a screw connection, to the inner circumference of the rotary part 21, and/or with a radially inner bearing housing which can be mounted onto the outer circumference of the wheel hub 5.

As is further apparent from FIG. 3, the bearing point 43 and the common pivot bearing point 31 are configured, purely by way of example, on axially opposite sides of the rotary part 21, with a gear portion 47 being positioned there between and forming part of the gear drive 30 (FIG. 1).

The axle-side guide part 17 is supported—analogous to the carrier part 3—to a pivot bearing 51 radially outwards upon the axle-side rotary part 23. In the further course in the vehicle transverse direction y inwardly, a further gear portion 55 is formed, for example, on the outer circumference of the axle-side rotary part 23 and represents also part of the gear drive 30. The gear portion 55 of the axle-side rotary part 23 is positioned in an annular space 57 which is bounded in the vehicle transverse direction y to the outside by the pivot bearing 51 and to the inside by an annular seal 59 which is arranged between the guide part 17 and the axle-side rotary part 23. The annular seal 59 in addition to the mobile seal 63 (i.e. rubber sleeve) is depicted only by way of example. Furthermore, seals may, of course, also be attached at all other bearing points.

In accordance with the invention, the wheel-side carrier part 3 supports—in addition to an electronic parking brake for example—only the brake caliper 15, the drive motor 29 for the wheel-side rotary part 21, and the torque support 61, to be described later, but does no longer support the wheel bearing 12. As a result, the pivot bearing 43 in particular between the carrier part 3 and the wheel-side rotary part 21 is removed from the wheel force flux. In terms of the encountered wheel forces, this results in that three bearing points only are arranged in series, i.e. the wheel bearing 12, the pivot bearing 31 and the support bearing 51, but not the bearing point 43 where the carrier part 3 is supported on the wheel-side rotary part 21. Therefore, the bearing point 43 placed on the wheel-side rotary part 21 can be dimensioned significantly smaller since the wheel forces and torques encountered there are much smaller. By removing the bearing point 43 from the wheel force flux, camber stiffness of the bearing assembly is increased in addition, so that the remaining bearings, i.e. the wheel bearing 12, the pivot bearing 31, and the support bearing 51, can be dimensioned smaller—compared to the state of the art—while maintaining camber stiffness.

A connection rod 61 is mounted in FIG. 2 between the carrier part 3 and the guide part and operates as a torque transmission element via which a torque, in particular a braking torque, can be transmitted from the carrier part 3 to the guide part 17. The connection rod 61 is arranged radially outside of a circumferential sleeve 63 which seals the rotary parts 21, 23 and their bearing points against ingress of dirt.

What is claimed is:

1.-11. (canceled)

12. A device for adjusting camber and/or toe of a vehicle wheel of a motor vehicle, comprising:
a wheel carrier supporting a brake caliper interacting with a brake disc of the vehicle wheel, said wheel carrier including a wheel-side carrier part, an axle-side guide part and wheel-side and axle-side rotary parts arranged between the carrier part and the guide part;
a wheel bearing received in the wheel carrier for rotatably mounting the vehicle wheel on the wheel carrier;
a common bearing point supporting the rotary parts for rotation relative to one another about a rotation axis about which the wheel-side rotary part is pivotable for toe or camber adjustment of the vehicle wheel about a wobble point; and
a pivot bearing configured to support the carrier part upon the wheel-side rotary part.

13. The device of claim 12, wherein the wheel bearing is detachable and includes a radially inner bearing housing detachably mounted to an outer circumference of a wheel hub, and a radially outer bearing housing detachably mounted to an inner circumference of the rotary part.

14. The device of claim 12, wherein the wheel bearing includes a radially inner bearing housing and a radially outer bearing housing, said outer bearing housing being formed directly by the wheel-side rotary part, with a wheel hub portion of a wheel flange, which supports the vehicle wheel, being rotatably mounted radially within the wheel-side rotary part.

15. The device of claim 13, wherein the inner bearing housing is detachably mounted to the outer circumference of the wheel hub by a press fit and/or by threaded engagement.

16. The device of claim 12, wherein the wheel bearing is integrated in the wheel-side rotary part.

17. The device of claim 12, wherein the wheel bearing is constructed to rotatably support a wheel hub portion of a wheel flange which supports the vehicle wheel.

18. The device of claim 12, wherein the carrier part is arranged radially outside of the wheel-side rotary part.

19. The device of claim 12, wherein the pivot bearing, disposed between the wheel-side carrier part and the wheel-side rotary part, and the common bearing point, disposed between the wheel-side rotary part and the axle-side rotary part, are positioned on axially opposite sides of the wheel-side rotary part.

20. The device of claim 12, further comprising a gear drive configured to drive the wheel-side rotary part and including a gear portion which is disposed on the wheel-side rotary part and arranged between the pivot bearing and the common bearing point, as viewed in an axial direction.

21. The device of claim 12, wherein the guide part is configured for articulation of at least one control arm of a wheel suspension of the vehicle, and further comprising a further pivot bearing configured to support the guide part upon the axle-side rotary part.

22. The device of claim 12, wherein the guide part is arranged radially outside of the axle-side rotary part.

23. The device of claim 12, further comprising a radially inner pivot bearing configured to support the guide part upon the axle-side rotary part.

24. The device of claim 12, wherein the wheel carrier includes between the carrier part and the guide part a torque transmission element, via which a torque is transmittable from carrier part to the guide part, while bridging the rotary parts.

25. The device of claim 24, wherein the torque is a braking torque.

26. The device of claim 12, further comprising a sleeve arranged between the carrier part and the guide part for sealing the rotary parts against ingress of dirt.

27. The device of claim 24, further comprising a circumferential sleeve arranged between the carrier part and the guide part, said torque transmission element being arranged radially outside of the circumferential sleeve.
